(19) United States
(12) Patent Application Publication
(10) Pub. No.: US 2014/0122914 A1
(43) Pub. Date: May 1, 2014

(54) VOLTAGE DETECTION SYSTEM FOR MEMORY MODULE

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: KANG WU, Shenzhen (CN); GUO-YI CHEN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/024,631

(22) Filed: Sep. 12, 2013

(30) Foreign Application Priority Data
Oct. 31, 2012 (CN) 2012104260795

(51) Int. Cl. G06F 11/30

(52) U.S. Cl. CPC G06F 11/3062
USPC 713/340

(57) ABSTRACT

A voltage detection system for a number of memory slots includes a platform controller hub (PCH) chip and an integrated baseboard management controller (iBMC) chip. The PCH chip obtains a type of an actual voltage of each memory slot, and outputs a corresponding control signal to the iBMC chip. The iBMC chip obtains the type of the actual voltage of each memory slot according to the corresponding control signal, and diagnoses the memory set with the type of actual voltage type of the corresponding memory set.

### BACKGROUND

1. Technical Field

The present disclosure relates to a voltage detection system for a memory module.

2. Description of Related Art

A voltage for a memory module of a server can be about 1.5 volts (V) while a memory module operating with a voltage of 1.35V can be used. The memory module operating with the voltage of 1.35V is more environmentally friendly. An integrated baseboard management controller (iBMC) chip may diagnostic the memory module with an original voltage type stored in the iBMC when the server bootstraps, to determine whether the memory module has a proper actual voltage type by comparing the actual voltage of the memory module with the original voltage type. If the actual voltage type of the memory module is same as the original voltage type stored in the iBMC chip, the iBMC determines that the memory module is in functional condition. Otherwise, if the actual voltage type of the memory module is not same as the original voltage type stored in the iBMC chip, the iBMC determines that the memory module malfunctions. However, if the actual voltage type of the memory module is changed, such as changing from 1.5V to 1.35V, but the original voltage type stored in the iBMC chip remains unchanged, that is 1.5V, the iBMC chip determines that the memory module may malfunction, for the original voltage type 1.5V being different from the actual voltage type 1.35V.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a voltage detection system of the present disclosure, wherein the voltage detection system includes a platform controller hub (PCH) chip and an integrated baseboard management controller (iBMC) chip.

FIG. 2 is a block diagram of the PCH chip and the iBMC chip of FIG. 1.

### DETAILED DESCRIPTION

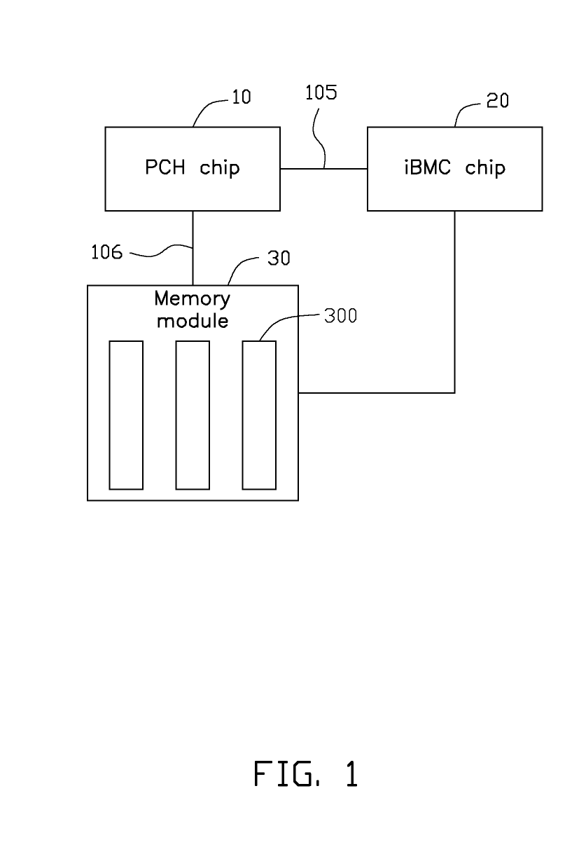

FIG. 1 illustrates an embodiment of a voltage detection system for a memory module 30 of the present disclosure. The voltage detection system includes a platform controller hub (PCH) chip 10 and an integrated baseboard management controller (iBMC) chip 20. The memory module 30 includes a plurality of memory sets 300.

The PCH chip 10 obtains types of actual rated voltages of the memory sets 300, and generates a control signal to the iBMC chip 20 corresponding to each memory set 300. In the embodiment, the PCH chip 10 outputs the control chip through a general purpose input output (GPIO) pin 105. The type of actual rated voltage of each of the memory sets 300 may be a first voltage type, e.g. 1.5 volts (V), or a second voltage type, e.g. 1.35V. The PCH chip 10 outputs a first control signal in response to the PCH chip 10 obtaining the type of the corresponding memory set 300 being the first voltage type, and outputs a second control signal in response to the PCH chip 10 obtaining the type of the corresponding memory set 300 being the second voltage type.

The iBMC chip 20 receives the control signal from the PCH chip 10, and determines the type of actual voltage of a corresponding memory set 300 according to the type of the control signal. For example, if the iBMC chip 20 receives the first control signal about one of the memory slots 300, the iBMC chip 20 determines that the type of an actual voltage of the memory set 300 is the first voltage type. Alternatively, when the iBMC chip 20 receives the second control signal about the memory set 300, the iBMC chip 20 determines that the type of the actual voltage of the memory set 300 is the second voltage type. The iBMC chip 20 stores the type of actual voltage corresponding to each memory set 300.

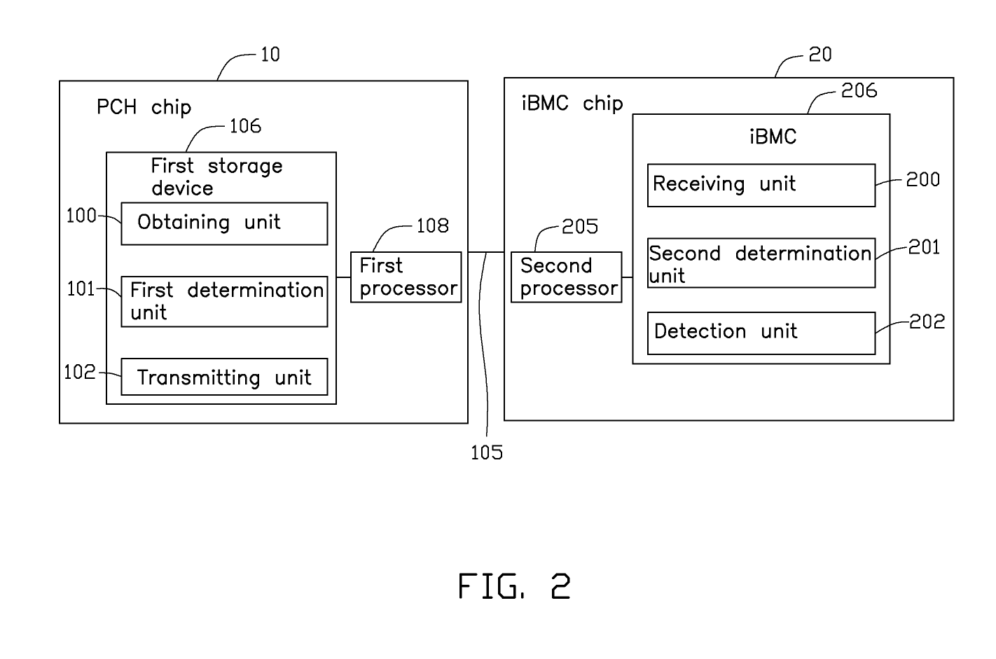

FIG. 2 shows that the PCH chip 10 a first processor 108 and a first storage device 106 coupled to the first processor 108, where the first storage device 106 includes a plurality of programs to be executed by the first processor 108 to perform certain functions. The first storage device 106 includes an obtaining unit 100, a first determination unit 101, and a transmitting unit 102. The obtaining unit 100 obtains the types of the actual voltages of the corresponding memory sets 300. In the embodiment, the PCH chip 10 obtains types of the actual voltages of the memory sets 300 through a system management bus (SMBus) 160. The first determination unit 101 determines whether the type of the actual voltage of corresponding memory set 300 is the first voltage type or the second voltage type, and generates the corresponding control signal. That is, if the type of the actual voltage of the memory set 300 is the first voltage type, the first determination unit 101 generates the first control signal with respect to the memory set 300 and controls the transmitting unit 102 to transmit the first control signal. If the type of the actual voltage of the memory set 300 is the second voltage type, the first determination unit 101 generates a second control signal with respect to the memory set 300, and controls the transmitting unit 102 to transmit the second control signal.

The iBMC chip 20 includes a second processor 205 and a second storage device 206 coupled to the second processor 205, where the second storage device 206 includes a plurality of programs to be executed by the second processor 205 to perform certain functions. The second storage device 206 includes a receiving unit 200, a second determination unit 201, and a detection unit 202. The receiving unit 200 receives the control signals from the PCH chip 10. The second determination unit 201 determines the type of the actual voltage of the corresponding memory set 300. For example, the second determination unit 201 determines that the type of actual voltage of the memory set 300 is the first voltage type on condition that the receiving unit 200 receives the first control signal corresponding to the memory set 300 from the PCH chip 10. In addition, the second determination unit 201 determines that the type of the actual voltage of the memory set 300 is the second voltage type on condition that the receiving unit 200 receives the second control signal corresponding to the memory set 300 from the PCH chip 10. The second determination unit 201 further transmits the types of actual voltages of corresponding memory sets 300 to the detection unit 202. The detection unit 202 then diagnostics the corresponding memory sets 300 with the types of actual voltages of corresponding memory sets 300, to diagnostic the memory module 30. Accordingly, the detection unit 202 detects the corresponding memory set 300 with the corresponding type of actual voltage, to avoid detecting the corresponding memory set 300 with a prior voltage type of the corresponding memory set 300.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A voltage detection system, comprising:
a platform controller hub (PCH) chip comprising a first processor and a first storage device coupled to the first processor, the first storage device storing a first plurality of programs to be executed by the first processor, the first plurality of programs comprising:
an obtaining unit obtaining actual voltages of corresponding memory sets;
a first determination unit determining types of the actual voltages of the corresponding memory sets, and generating corresponding control signals according to the types of the actual voltages of the corresponding memory sets; and
an integrated baseboard management controller (iBMC) chip comprising a second processor and a second storage device coupled to the second processor, the second storage device storing a second plurality of programs to be executed by the second processor, the second plurality of programs comprising:
a receiving unit receiving the corresponding control signals from the PCH chip;
a second determination unit obtaining types of actual voltages of the corresponding memory sets according to the corresponding control signals, and transmitting the type of actual voltage of each memory set; and
a detection unit diagnosing the corresponding memory set with the type of actual voltage of the corresponding memory set.

2. The voltage detection system of claim 1, wherein the types of the actual voltages of the memory sets comprise a first voltage type and a second voltage type, the first determination unit determines whether the type of the actual voltage of the corresponding memory set is the first or the second memory set; if the type of the actual voltage of the memory set is the first voltage type, the first determination unit generates a first control signal; if the type of the actual voltage of the memory set is the second voltage type, the first determination unit generates a second control signal.

3. The voltage detection system of claim 2, wherein the second determination unit determines that the type of actual voltage of the corresponding memory set is the first voltage type in response to receiving the first control signal, and determines that the type of actual voltage of the corresponding memory set is the second voltage type in response to receiving the second control signal.

4. The voltage detection system of claim 3, wherein the first voltage type is 1.5 volts (V), and the second voltage type is 1.35V.

5. The voltage detection system of claim 4, wherein the PCH chip obtains the type of the actual voltage of each memory set through a system management bus (SMBus).

6. The voltage detection system of claim 5, wherein the PCH chip outputs the corresponding control signals through a general purpose input and output (GPIO) pin.
